(19) United States
(12) Patent Application Publication
(10) Pub. No.: US 2013/0241279 A1
(43) Pub. Date: Sep. 19, 2013

(54) HIGH VOLTAGE BUS DISCHARGE SYSTEM

(71) Applicants: Dan Schum, Lake Balboa, CA (US); Ali Maleki, Canton, MI (US); Bryan Grider, West Bloomfield, MI (US)

(72) Inventors: Dan Schum, Lake Balboa, CA (US); Ali Maleki, Canton, MI (US); Bryan Grider, West Bloomfield, MI (US)

(73) Assignee: Coda Automotive, Inc., Los Angeles, CA (US)

(21) Appl. No.: 13/418,803

(22) Filed: Mar. 13, 2012

(51) Int. Cl. B60L 1/00

(52) U.S. Cl. 307/9.1

(57) ABSTRACT

Systems and methods for discharging a high voltage bus of an electric vehicle are disclosed. In some instances, the discharge components coupled to the high voltage bus may be located in different remotely located portions of the electric vehicle to increase reliability of the high voltage bus discharge system.

### BACKGROUND

During the operation of an electric vehicle, including hybrid electric vehicles, a high voltage bus is used to distribute operating power to components throughout the car. The high voltage bus may deliver power at voltages of approximately 330 volts. When the vehicle is no longer in operation, the high voltage bus may undesirably remain charged at this elevated voltage, even when the battery is disconnected. This may be due to the capacitance of a number of components connected to the high voltage bus as well as the possible capacitance of the high voltage bus itself. Therefore, when not in operation, or in certain other circumstances, it may be desirable to discharge the high voltage bus. This may be done for any number of reasons including, but not limited to, maintenance work, component access, and post-accident shut down.

### SUMMARY

The high voltage bus may advantageously be discharged using any number of discharge components operatively coupled to the high voltage bus. These components may include passive discharge components that do not require additional power to discharge the high voltage bus and/or active discharge components that require power to discharge the high voltage bus. Non-limiting examples of possible discharge components include, but are not limited to, an inverter, a DCDC converter, and a positive temperature coefficient heater. In addition to the above, the inventors have recognized the benefits of providing redundant components for discharging a high voltage bus located in different portions of a vehicle. In this way, if damage to a portion of the vehicle occurs rendering one discharge component inoperable or otherwise unavailable to discharge the high voltage bus, then an alternate discharge component located in another undamaged area of the vehicle may be used for discharging the high voltage bus.

In one embodiment, an electric vehicle may include a high voltage bus. A first discharge component located in a first area of the vehicle may be operatively connected to the high voltage bus. A second discharge component located in a second area of the vehicle may also be operatively connected to the high voltage bus. The first area may be located remotely from the second area in a different portion of the electric vehicle.

In another embodiment, an electric vehicle may include a high voltage bus. The vehicle may also include a plurality of discharge components operatively coupled to the high voltage bus to discharge the high voltage bus. At least two of the plurality of discharge components may be located in different remotely located portions of the electric vehicle.

In yet another embodiment, a method for discharging an electric vehicle high voltage bus may include dissipating energy from a high voltage bus in a first discharge component located in a first area. The method may also include dissipating energy from the high voltage bus in a second discharge component located in a second area. The first area may be located remotely from the second area in a different portion of the electric vehicle.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic representation of multiple discharge components located in different portions of an electric vehicle;

FIG. 2 is a schematic representation of the high voltage bus discharge system; and

FIG. 3 is a representative flow diagram of the operation of a high voltage bus discharge system.

### DETAILED DESCRIPTION

The inventors have recognized the benefits of providing redundant components for discharging a high voltage bus. The inventors have also recognized that it may be desirable to arrange the various redundant components of the high voltage bus discharge system so that damage to any single portion of the vehicle is unlikely to disable the entire high voltage bus discharge system. For example, in the event of a crash the under hood portion of the car could be significantly damaged. If a discharge system were located completely in the damaged portion of the vehicle, it could be disabled, resulting in the high voltage bus being unable to discharge normally. In addition to the above noted crash scenario, discharge components could also be disabled due to wiring damage, thermal damage, component failure, connection failures, communications failures, power failures, and other applicable failure modes that could result in a discharge component, and possibly other adjacent discharge components, becoming inoperable or otherwise unable to discharge the high voltage bus. In view of the above noted failure modes, it is desirable to locate at least one discharge component of the high voltage bus discharge system in a different portion of the electric vehicle located remotely from the other discharge components to reduce the likelihood of damage to a single portion of the electric vehicle disabling the entire high voltage bus discharge system.

For the sake of clarity the current disclosure primarily discusses applications directed at providing redundant discharge of the high voltage bus during a vehicle crash. However, the current disclosure is not limited in this fashion. Instead, the current application should be viewed as generally disclosing the benefits of providing redundant discharge components in different remotely located portions of an electric vehicle to avoid disabling the high voltage bus discharge system due to damage to any single portion of the vehicle. For example, a discharge component might be disabled due to physical damage of the component itself (e.g. from a crash), or other damage such as wiring damage, thermal damage, hardware failures, connection failures, communications failures, power failures, and other applicable failure modes. Therefore, regardless of the particular failure mode experienced, it may be advantageous to have at least one discharge component located in a different portion of the vehicle to reduce the possibility of the failure mode affecting the entire high voltage bus discharge system.

While specific discharge components are discussed below, the disclosure is also broad enough to include any component connected to the high voltage bus capable of dissipating energy. These components may include passive discharge components, i.e. components that may discharge the high voltage bus without being externally powered, and active discharge components, i.e. components that must be externally powered to discharge the high voltage bus.

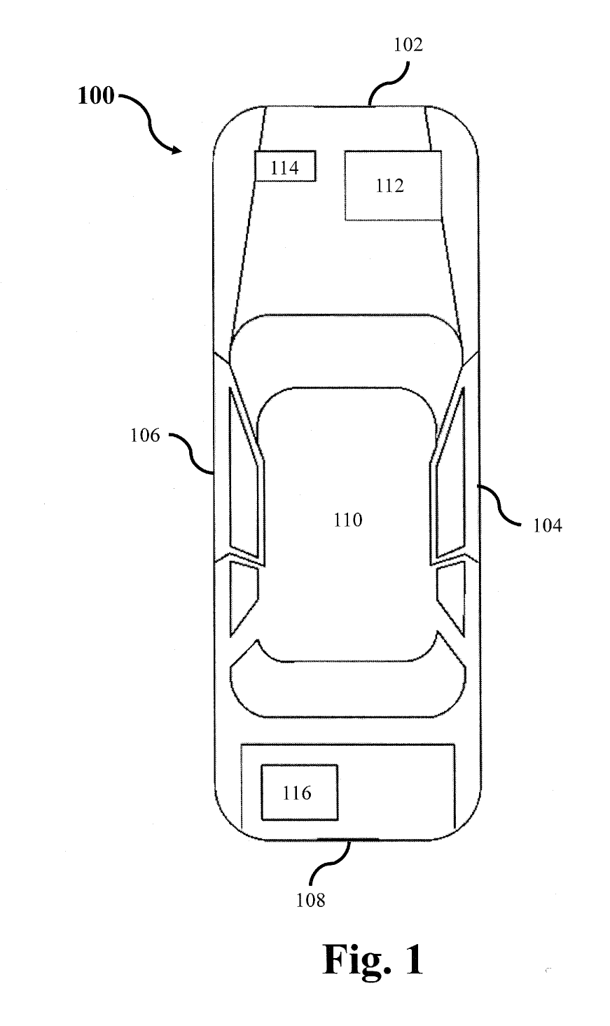

In one embodiment, as illustrated in FIG. 1, an electric vehicle 100 (which may be an all-electric vehicle or a hybrid electric vehicle) includes a front portion 102, a passenger side portion 104, a driver side portion 106, a rear portion 108, and a central portion 110. For example, the front portion of the electric vehicle could include the under hood area and the rear portion of the electric vehicle could include the trunk area. In this embodiment, the electric vehicle includes three separate discharge components 112, 114, and 116. As illustrated in the figure, two of the discharge components, 112 and 114, are located towards the forward portion of the electric vehicle corresponding to the under hood area. Another redundant discharge component 116 is located in a separate area within the rear portion of the car possibly corresponding to the trunk area. By placing the different discharge components in strategic locations around the vehicle, such as the front and rear portions as depicted in FIG. 1, it may be possible to retain the functionality of the high voltage bus discharge system even when one or more components are disabled. When the discharge components are disabled they may be inoperable or otherwise incapable of discharging the high voltage bus. For example, discharge components 112 and 114 could be disabled due to a front end impact, either by directly damaging the discharge components or damaging their connectivity to the high voltage bus discharge system. In such an instance, redundant discharge component 116 located in the rear portion of the electric vehicle might still be functional and capable of discharging the high voltage bus. In some embodiments, the various discharge components discussed above may include an inverter, a Positive Thermal Coefficient (PTC) heater, a DCDC converter, and any other appropriate power dissipating component operatively connected to the high voltage bus.

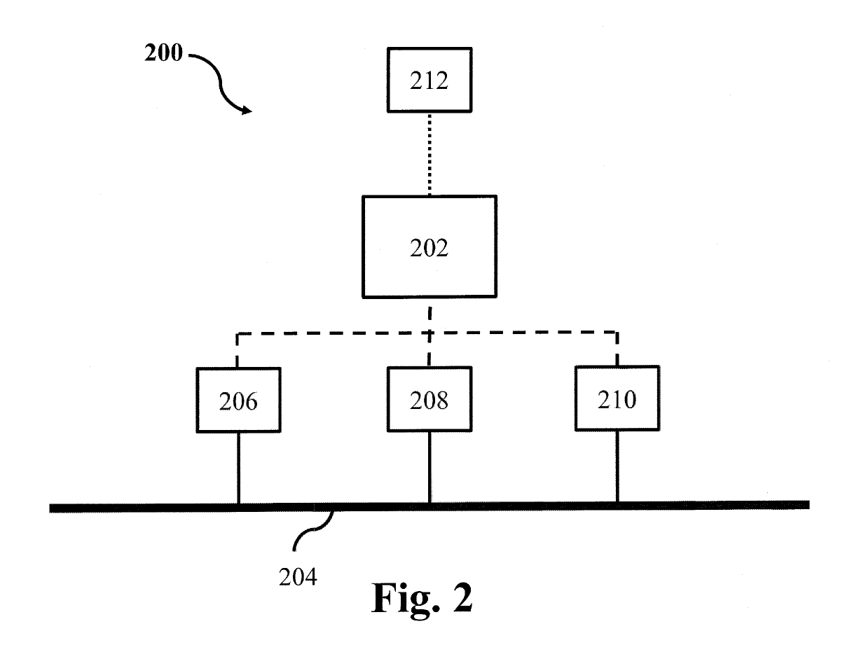

One embodiment of the high voltage bus discharge system is presented in FIG. 2. In the presented embodiment, the high voltage bus discharge system 200 may include a controller 202 capable of coordinating the operation of the different discharge components according to sensed events and requests. The controller may be in controlling communication with the various redundant discharge components 206, 208, and 210. The system may also include a variety of sensors 212 that are in communication with the controller. The controller may control discharge of the high voltage bus 204 according to the inputs detected by sensors 212. The methods of operation implemented by the controller in response to the sensed inputs are described in more detail below. While a single controller has been depicted it should be understood that the controller could be a distributed system including multiple controllers, as the current disclosure is not limited in this fashion.

In order to discharge the high voltage bus in response to a number of situations, it may be desirable for the various sensors to provide information related to multiple vehicle inputs and requests. For example, in some embodiments, an acceleration sensor input may be used to determine if a crash has occurred. Externally supplied discharge requests may also be sensed to permit the high voltage bus to be discharged prior to vehicle maintenance and repair. In addition, a controlled shut down and discharge of the high voltage bus may be implemented when the sensors detect a key off position, or the electric vehicle exits a charging mode, indicating that the vehicle should be powered off for parking and/or storage. In other embodiments, it may be desirable to permit the high voltage bus discharge system to dissipate energy from the battery system when the sensors detect that the battery pack is fully charged during regenerative braking to permit additional regenerative braking to be applied. While specific situations and inputs have been described above, it should be understood that any number of alternative, or additional, inputs and requests would be readily apparent to one of skill in the art and the current disclosure is not limited merely to those inputs and situations disclosed herein.

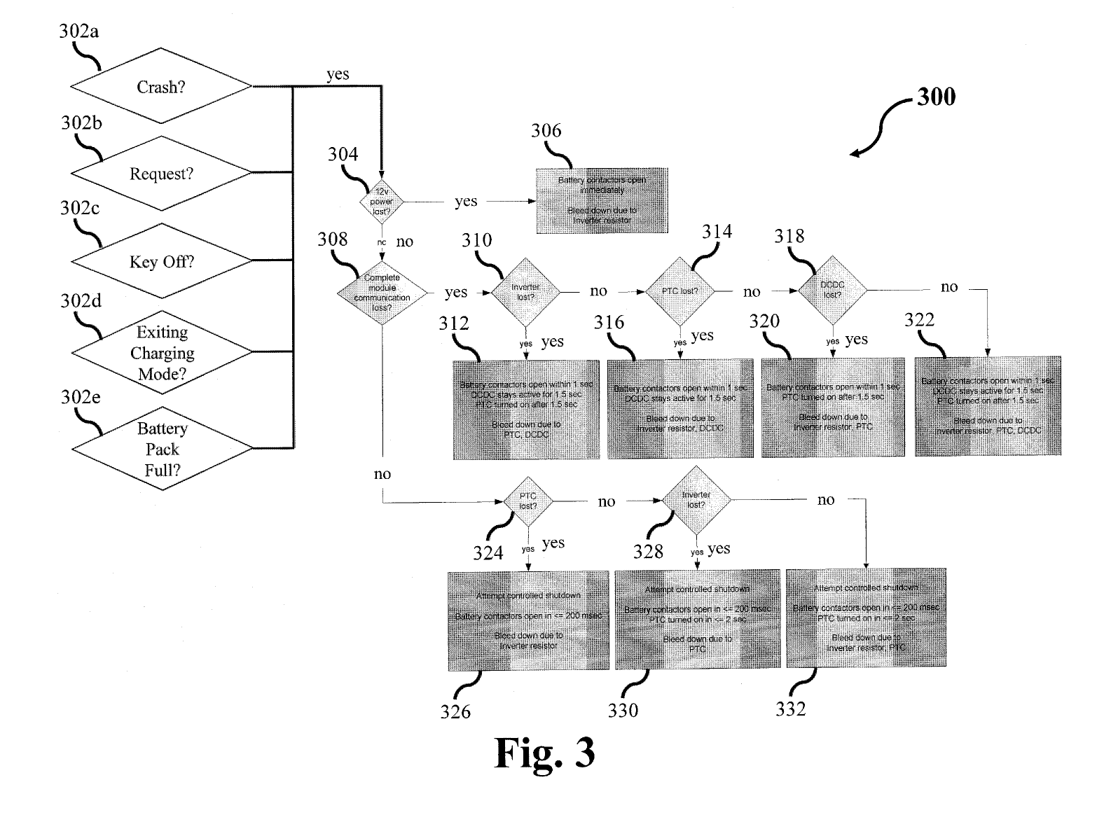

In addition to providing redundant discharge components in different portions of the electric vehicle, in some embodiments it may be desirable to enable a control strategy capable of coping with a disabled discharge component due to: a loss of power to the discharge component; a loss of communication with the discharge component; and/or one or more discharge components being damaged or otherwise inoperable. An exemplary method of operation 300 implementing the above concept is depicted in FIG. 3. In this embodiment, the high voltage bus discharge system may include redundant discharge components such as an inverter, a PTC heater, and a DCDC converter located in different portions of the electric vehicle. A sensor may sense an electric vehicle state or request such as a crash 302a, a discharge request 302b, a key off position 302c, a charging mode exit signal 302d, a battery pack full signal 302e, or any other appropriate state or request. If one or more of the above states or requests is detected, a controller may then determine if the 12V power supply is available in step 304. If the 12V power supply is not available due to a fault or damage, the battery contactors may be opened and the high voltage bus may be discharged using a passive discharge component such as the resistor in the inverter 306. If the 12V power supply is available, active discharge components may be used instead as described in more detail below. However, the disclosure is not limited in this fashion. For example, passive discharge elements may be used even when the 12V power supply is available.

After determining if the 12V power supply is available, the controller may subsequently determine if there is a communication failure with the discharge components of the high voltage bus discharge system 308. A communication failure could be the result of a single point or multipoint failure. For example, the individual failures could be the result of a discharge component being damaged, a communication wire being damaged, a coupling being loose or damaged, or any other applicable failure mode. Regardless of the source of failure, if there is complete communication failure with the discharge system, the controller may command any of the redundant and still functioning discharge components to turn on/remain on so as to discharge the high voltage bus. This may include both passive and active discharge components. For example, at 310-322, after complete module communication loss, the controller may command the battery contactors to open within 1 second and the system may discharge the high voltage bus by using the passive inverter resistor, commanding the DCDC converter to stay active for approximately 1.5 seconds, and turning the PTC heater on after 1.5 seconds. Depending on which of the redundant discharge components are still functioning, this could result in the high voltage bus being discharged by all of the discharge components or by a single functional discharge component. While specific examples of times have been given above, the disclosure is not limited in this fashion. For example, since the DCDC converter would have been on during operation it could simply be left on for an indefinite, or predetermined, period of time. Alternatively, the PTC heater could be commanded to operate continuously as long as there is power left in the high voltage bus. Therefore, the above disclosure should be viewed as generally disclosing using any functional discharge component to discharge the high voltage bus in the event of a communication failure. This may include either commanding functioning active discharge components to turn on/remain on, or using passive discharge components to discharge the high voltage bus.

If communications with the high voltage bus discharge system are still available, the controller may determine which of the redundant discharge components are still functional prior to commanding a controlled shutdown. For example, if the PTC heater is no longer functioning due to either it being inoperative or otherwise unable to discharge the high voltage bus, 324, the controller may command that the battery contactors open within approximately 200 ms or less, and the high voltage bus may be discharged using the passive inverter resistor as at 326. If the inverter is no longer functioning due to either it being inoperative or otherwise unable to discharge the high voltage bus, 328, the controller may open the battery contactors within approximately 200 ms and the PTC heater may be commanded on within approximately 2 sec or less to discharge the high voltage bus 330. If both the PTC heater and inverter are functional, the controller may open the battery contactors within approximately 200 ms or less, turn the PTC heater on within approximately 2 seconds or less, and use the passive inverter resistor to discharge the high voltage bus 332. By applying the redundant systems in the above disclosed fashion, the control system may complete a controlled shut down of the vehicle and discharge the high voltage bus. While specific times and discharge components have been mentioned above, the disclosure is not limited to the specific components or times specified. For example, the battery contacts could be opened after a longer or shorter time delay. Similarly, the PTC heater could be turned on after a longer or shorter time delay and could be maintained on for either a predetermined period of time, or an indefinite period of time. Furthermore, while the inverter and PTC heater have been discussed with regards to a controlled shutdown, any appropriate discharge component, including the DCDC converter, could be used in place of, or in addition to, the discussed components.

While the above disclosed high voltage bus discharge system only includes a single passive discharge component, namely the inverter, it may be desirable to provide multiple passive discharge components connected to the high voltage bus at different locations. For example, a passive discharge component may be included near, or inside of, any component that stores energy and is connected to the high voltage bus. In some instances, the components may have a relatively large capacitance as compared to other components connected with the high voltage bus. Consequently, if a crash, or other fault, were to disable the active discharge components associated with the discharge system, the components that store relatively large amounts of energy could still dissipate their stored energy, as long as their associated passive discharge components remained functional.

The various methods or processes outlined herein may be coded as software that is executable on one or more processors with associated memory storage that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the disclosed methods of operation may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various methods discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement the various embodiments discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform the disclosed methods need not reside on a single computer or processor, but may be distributed in a modular fashion amongst a number of different computers or processors to implement various aspects of the present invention.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An electric vehicle comprising:
a high voltage bus;
a first discharge component located in a first area and operatively connected to the high voltage bus; and
a second discharge component located in a second area and operatively connected to the high voltage bus, wherein the first area is located remotely from the second area in a different portion of the electric vehicle.

2. The electric vehicle of claim 1 wherein the first area is located in a front portion of the electric vehicle.

3. The electric vehicle of claim 1 wherein the second area is located in a rear portion of the electric vehicle.

4. The electric vehicle of claim 1 wherein the first discharge component is an inverter, PTC heater, or DC-DC converter.

5. The electric vehicle of claim 4 wherein the second discharge component is different from the first discharge component and is an inverter, PTC heater, or DC-DC converter.

6. The electric vehicle of claim 1 further comprising a controller in controlling communication with the first and second discharge components.

7. The electric vehicle of claim 6 further comprising a sensor operatively connected to the controller, wherein the controller commands at least one of the discharge components to discharge the high voltage bus in response to a sensed state by the sensor.

8. The electric vehicle of claim 7 wherein the sensed state is a crash event, a key off state, the vehicle exiting a charging mode, a battery pack full condition, or a disabled discharge component.

9. The electric vehicle of claim 1 wherein at least one of the first and second discharge components passively discharges the high voltage bus.

10. The electric vehicle of claim 1 wherein at least one of the first and second discharge components actively discharges the high voltage bus.

11. An electric vehicle comprising:
a high voltage bus;
a plurality of discharge components operatively coupled to the high voltage bus to discharge the high voltage bus, wherein at least two of the plurality of discharge components are located in different remotely located portions of the electric vehicle.

12. The electric vehicle of claim 11 wherein the different remotely located portions of the electric vehicle comprise front and rear portions of the electric vehicle.

13. The electric vehicle of claim 11 wherein the plurality of discharge components comprise at least one of an inverter, PTC heater, and DC-DC converter.

14. The electric vehicle of claim 11 further comprising a controller in controlling communication with the plurality of discharge components.

15. The electric vehicle of claim 14 further comprising a sensor operatively connected to the controller, wherein the controller commands at least one of the plurality of discharge components to discharge the high voltage bus in response to a sensed state by the sensor.

16. The electric vehicle of claim 15 wherein the sensed state is a crash event, a key off state, the vehicle exiting a charging mode, a battery pack full condition, or a disabled discharge component.

17. The electric vehicle of claim 11 wherein at least one of the plurality of discharge components passively discharges the high voltage bus.

18. The electric vehicle of claim 11 wherein at least one of the plurality of discharge components actively discharges the high voltage bus.

19. A method for discharging an electric vehicle high voltage bus, the method comprising:
dissipating energy from a high voltage bus in a first discharge component located in a first area; and
dissipating energy from the high voltage bus in a second discharge component located in a second area, wherein the first area is located remotely from the second area in a different portion of the electric vehicle.

20. The method of claim 19, wherein dissipating energy in the second discharge component further comprising dissipating energy in the second discharge component when the first discharge component is unavailable.

21. The method of claim 19 further comprising locating the first area in a front portion of the electric vehicle and the second area in a rear portion of the electric vehicle.

22. The method of claim 19 further comprising sensing an electric vehicle state, wherein the sensed state is at least one of a crash event, a key off state, the vehicle exiting a charging mode, a battery pack full condition, or a disabled discharge component.

23. The method of claim 22 further comprising commanding at least one of the discharge components to discharge the high voltage bus in response to the sensed electric vehicle state.
